(19) United States
(12) Patent Application Publication
(10) Pub. No.: US 2026/0058802 A1
(43) Pub. Date: Feb. 26, 2026

(54) SYSTEMS AND METHODS FOR MIDDLE-MILE QUANTUM KEY DISTRIBUTION

(71) Applicant: JPMORGAN CHASE BANK, N.A., New York, NY (US)

(72) Inventors: Charles LIM, Singapore (SG); Obada ALIA, Bristol (GB); Albert HUANG, Singapore (SG); Omar AMER, New York, NY (US); Randy LAI, Singapore (SG); Jefferson CHU, Singapore (SG)

(21) Appl. No.: 18/774,691

(22) Filed: Jul. 16, 2024

(51) Int. Cl. H04L 9/08

(52) U.S. Cl. CPC H04L 9/0852; H04L 9/0819

(57) ABSTRACT

A method may include: (1) receiving, at a quantum key distribution node in a network of a plurality of quantum key distribution nodes, a quantum key; (2) distributing, by the quantum key distribution node, the quantum key to the other quantum key distribution nodes over a subset of the direct connections; (3) communicating, by one of the plurality of quantum key distribution nodes, the quantum key to a central key management service node, wherein the central key management service node is hardwired to the quantum key distribution node; (4) communicating, by the central key management service node, the quantum key to a secondary key management service node; (5) communicating, by the secondary key management service node, the quantum key to a last mile device; and (6) using, by the last mile device, the quantum key to encrypt or decrypt data.

### BACKGROUND OF THE INVENTION

### 1. Field of the Invention Embodiments relate to systems and methods for middle-mile quantum key distribution.

### 2. Description of the Related Art

Classical quantum key delivery networks require physical optical links to deliver the keys to network participants. These physical optical links, however, do not always exist, and are sometimes not justified by the cost.

### SUMMARY OF THE INVENTION

Systems and methods for middle-mile quantum key distribution are disclosed. In one embodiment, a method may include: (1) receiving, at one of a plurality of quantum key distribution nodes in a network of a plurality of quantum key distribution nodes, a quantum key, wherein the each of the plurality of quantum key distribution nodes has a direct connection with the other quantum key distribution nodes; (2) distributing, by the quantum key distribution node, the quantum key to the other quantum key distribution nodes over a subset of the direct connections; (3) communicating, by one of the plurality of quantum key distribution nodes, the quantum key to a central key management service node, wherein the central key management service node may be hardwired to the quantum key distribution node; (4) communicating, by the central key management service node, the quantum key to a secondary key management service node; (5) communicating, by the secondary key management service node, the quantum key to a last mile device; and (6) using, by the last mile device, the quantum key to encrypt or decrypt data.

In one embodiment, each quantum key distribution node may be associated with one region of a plurality of regions.

In one embodiment, the region may be associated with one of the quantum key distribution nodes, the central key management service node, and a plurality of the secondary key management service nodes.

In one embodiment, the central key management service node communicates the quantum key to the secondary key management service node using wireless communication.

In one embodiment, the central key management service node communicates the quantum key to the secondary key management service node using symmetric encryption.

In one embodiment, the central key management service node communicates the quantum key to the secondary key management service node using distributed database mechanisms.

In one embodiment, the last mile device may include the secondary key management node.

In one embodiment, the last mile device may be hardwired to the secondary key management node.

In one embodiment, the last mile device may include a router or a server.

According to another embodiment, a system may include: a network comprising a plurality of quantum key distribution nodes, each quantum key distribution node having a direct connection with the other quantum key distribution nodes and associated with a region; a central key management service device in each region and in hardwired communication with the quantum key distribution node in the region; a plurality of secondary key management service devices in each region and in wired or wireless communication with the central key management service device; and a plurality of last mile devices in each region, each of the plurality of last mile devices in hardwired communication with one of the plurality of secondary key management devices in the region.

In one embodiment, one of the quantum key distribution nodes may be configured to receive a quantum key and to distribute the quantum key to the other quantum key distribution nodes over a subset of the direct connections; one of the plurality of quantum key distribution nodes may be configured to communicate the quantum key to the central key management service node in the region; the central key management service node may be configured to communicate the quantum key to one of the secondary key management service nodes in the region; the secondary key management service node may be configured to communicate the quantum key one of the last mile devices in the region; and the last mile device may be configured to use the quantum key to encrypt or decrypt data.

In one embodiment, each region may be defined by a geographical area.

In one embodiment, each region may be defined by a building.

In one embodiment, the direct connections comprise an optical fiber or a satellite link.

In one embodiment, the last mile device may include the secondary key management node.

In one embodiment, the last mile device may be hardwired to the secondary key management node.

In one embodiment, the last mile device may include a router or a server.

In one embodiment, the central key management service node communicates the quantum key to the secondary key management service node using symmetric encryption.

In one embodiment, the system may also include a plurality of databases in the region, wherein the central key management service node communicates the quantum key to the secondary key management service node using distributed database mechanisms.

In one embodiment, the central key management service nodes and/or the secondary key management service nodes comprise hardware secure module devices.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for middle-mile quantum key distribution according to an embodiment;

FIG. 2 illustrates a method for middle-mile quantum key distribution according to an embodiment;

FIG. 3 depicts an exemplary computing system for implementing aspects of the present disclosure.

### DETAILED DESCRIPTION OF PREFERRED EMBODIMENTS

Embodiments relate to systems and methods for middle-mile quantum key distribution.

Embodiments may use a key management system to distribute keys to the nodes. The key management system may manage cryptographic keys and their metadata (e.g., generation, distribution, storage, backup, archive, recovery, use, revocation, and destruction). An automated key management system may be used to oversee, automate, and secure the key management process.

The key management system may communicate quantum keys securely to other nodes in the system using techniques such as a pre-shared key.

Embodiments leverage the key management system to transfer quantum keys between nodes that have devices that use quantum keys, as well as to nodes that do not have devices that use quantum keys.

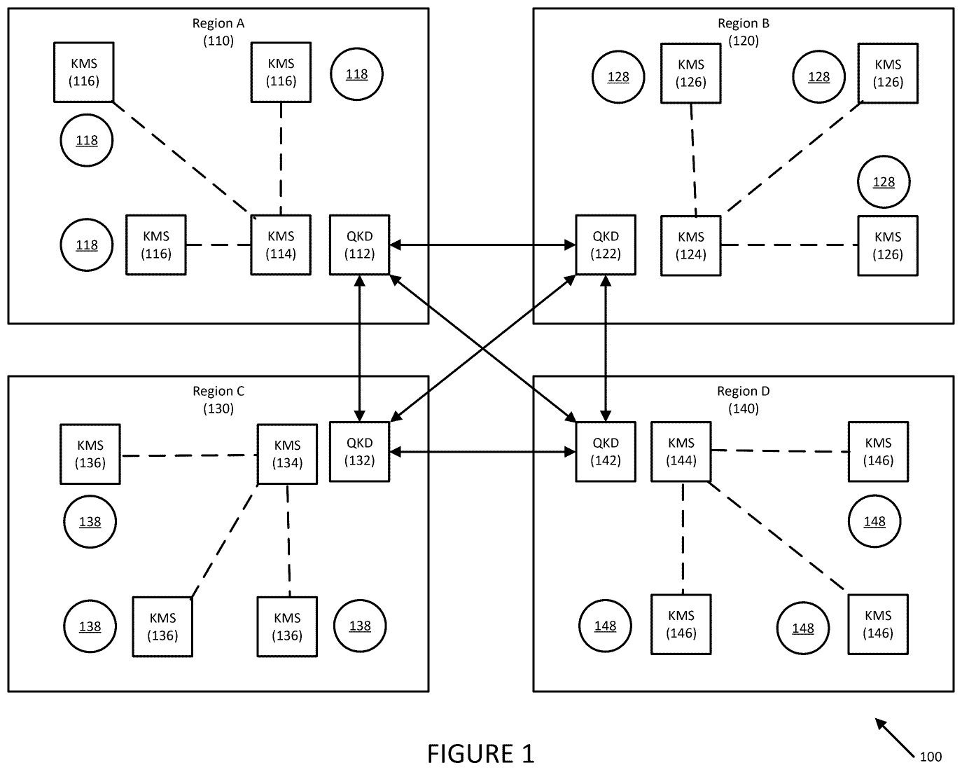

Referring to FIG. 1, a system for middle-mile quantum key distribution is disclosed according to an embodiment. System 100 may include a plurality of regions, such as region A 110, region B 120, region C 130, and region D 140. Although four regions are illustrated in FIG. 1, it should be recognized that additional regions, or fewer regions, may be provided as is necessary and/or desired.

Each region 110, 120, 130, 140 may include quantum key distribution (QKD) node (e.g., 112, 122, 132, 142), each of which may be connected to the others by a direct fiber connection, a satellite link, etc. The quantum key distribution nodes (e.g., 112, 122, 132, 142) and their connections may form a network of quantum key distribution nodes.

Each quantum key distribution node may include a QKD device, which may include key distribution appliances that distribute secret keys to link encryptors, link encryptors that use the keys provided by the link encryptors to encrypt and decrypt data, an optical source that generates the photons that are used in quantum communications, quantum state preparation device that prepares the quantum states of the photons before they are sent through the communication channel, a modulation scheme device that modules the quantum states to encode information, a digital processor and communication device that processes the quantum signals and manages communications between devices, and a single photon detector that detects individual photons that carry the quantum information.

Examples of systems and methods for quantum key distribution are disclosed in U.S. patent application Ser. No. 18/174,768 and U.S. patent application Ser. No. 18/305,039, the disclosure of which are hereby incorporated, by reference, in their entireties.

Each node may further include key management system nodes, including central KMS nodes (e.g., 114, 124, 134, 144) and secondary KMS nodes (e.g., 116, 126, 136, 146). In one embodiment, central KMS nodes (e.g., 114, 124, 134, 144) and secondary KMS nodes (e.g., 116, 126, 136, 146) may be implemented on a traditional server that may include a hardware secure module (HSM) device.

HSM devices are physical computing devices that safeguard and manage secrets, such as quantum keys, perform encryption/decryption functions for digital signatures, strong authentication, and other cryptographic functions.

In one embodiment, central KMS nodes 114, 124, 134, 144 may be collocated with QKD nodes 112, 122, 132, 142, respectively. Central KMS nodes 114, 124, 134, 144 may communicate with secondary KMS nodes 116, 126, 136, 146, respectively, via wired communication or wireless communion. The quantum keys may be distributed using any suitable mechanism or strategy used by central KMS nodes (e.g., 114, 124, 134, 144) and secondary KMS nodes (e.g., 116, 126, 136, 146), such as symmetric encryption and leveraging distributed database mechanisms to communicate the quantum keys, etc.

Example of distributed database mechanisms include the Raft protocol, the Paxos protocol, the Practical Byzantine Fault Tolerance (PBFT) protocol, and their descendants.

Regions 110, 120, 130, 140 may also be provided with last mile devices (e.g., 118, 128, 138, 148), such as servers, routers, NFC key points, or any other suitable electronic device. Last mile devices (e.g., 118, 128, 138, 148) may receive a quantum key from one of the secondary KMS nodes (e.g., 116, 126, 136, 146) and may use it to encrypt or decrypt data as necessary.

In one embodiment, last mile devices (e.g., 118, 128, 138, 148), may use standardized cryptography interfaces such as PKCS11, KMIP, ETSI014 for data encryption/decryption or QKD key export.

In one embodiment, last mile devices (e.g., 118, 128, 138, 148) may be hardwired to one of the central KMS nodes (e.g., 114, 124, 134, 144) or secondary KMS nodes (e.g., 116, 126, 136, 146). In another embodiment, a central KMS node (e.g., 114, 124, 134, 144) or a secondary KMS node (e.g., 116, 126, 136, 146) may be integrated into last mile devices (e.g., 118, 128, 138, 148).

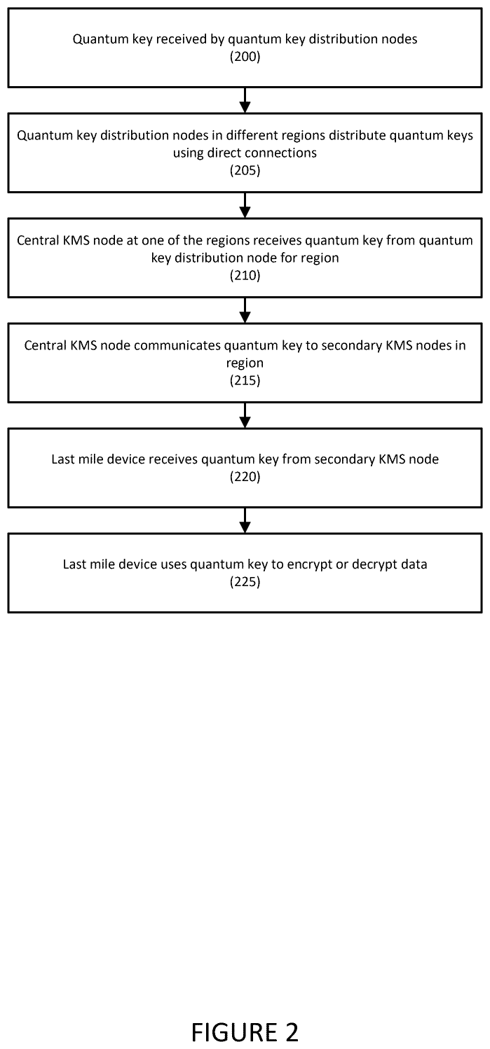

Referring to FIG. 2, a method for middle-mile quantum key distribution is disclosed according to an embodiment.

In step 200, one or more quantum key(s) may be received by one or more quantum key distribution nodes. The quantum key(s) may be generated by one of the quantum key distribution nodes, received from a quantum key distribution channel, etc.

In step 205, as needed, the plurality of quantum key distribution nodes may distribute quantum key(s) to each other using direct connections. In one embodiment, each quantum key distribution node may be in a different region, such as a different building, different geographical area, etc.

The quantum key distribution nodes may communicate by, for example, direct optical fiber connection, satellite communication, etc.

In step 210, at a region, a central KMS node may receive a quantum key from the quantum key distribution node. In one embodiment, the KMS node may be hard wired to the quantum key distribution node.

In step 215, the central KMS node may communicate the quantum key to secondary KMS nodes in the region. The quantum key may be communicated by any suitable communication protocol, including wired, wireless, etc.

In step 220, a last mile device, such as a router, a server, etc. may receive the quantum key from one of the secondary KMS nodes. In one embodiment, the last mile device may be hardwired to the secondary KMS node, or the secondary KMS node may be integrated into the last mile device.

In step 225, the last mile device may use the quantum key to encrypt data, decrypt data, etc.

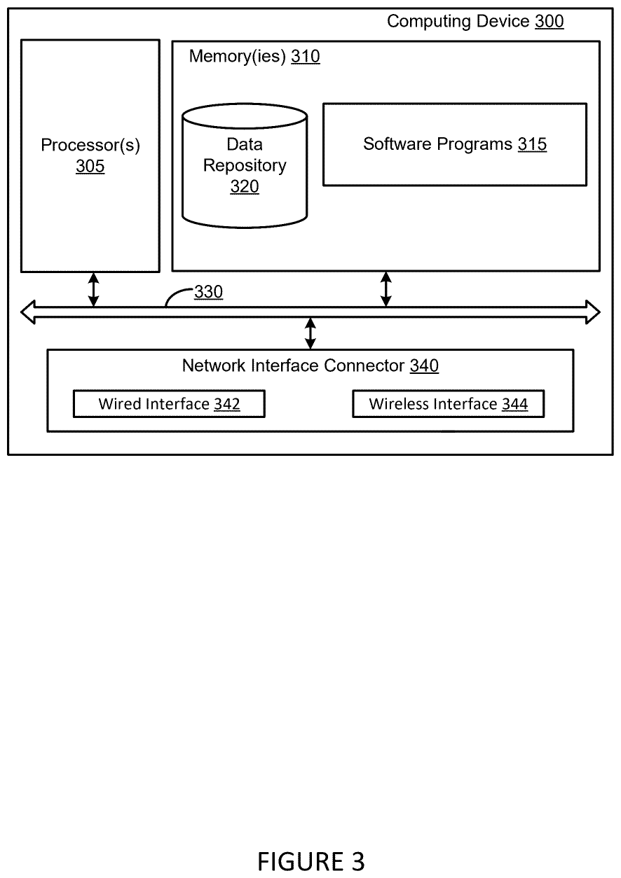

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, at one of a plurality of quantum key distribution nodes in a network of a plurality of quantum key distribution nodes, a quantum key, wherein each of the plurality of quantum key distribution nodes has a direct connection with the other quantum key distribution nodes;
distributing, by the quantum key distribution node, the quantum key to the other quantum key distribution nodes over a subset of the direct connections;
communicating, by one of the plurality of quantum key distribution nodes, the quantum key to a central key management service node, wherein the central key management service node is hardwired to the quantum key distribution node;
communicating, by the central key management service node, the quantum key to a secondary key management service node;
communicating, by the secondary key management service node, the quantum key to a last mile device; and
using, by the last mile device, the quantum key to encrypt or decrypt data.

2. The method of claim 1, wherein each quantum key distribution node is associated with one region of a plurality of regions.

3. The method of claim 2, wherein the region is associated with one of the quantum key distribution nodes, the central key management service node, and a plurality of the secondary key management service nodes.

4. The method of claim 1, wherein the central key management service node communicates the quantum key to the secondary key management service node using wireless communication.

5. The method of claim 1, wherein the central key management service node communicates the quantum key to the secondary key management service node using symmetric encryption.

6. The method of claim 1, wherein the central key management service node communicates the quantum key to the secondary key management service node using distributed database mechanisms.

7. The method of claim 1, wherein the last mile device comprises the secondary key management node.

8. The method of claim 1, wherein the last mile device is hardwired to the secondary key management node.

9. The method of claim 1, wherein the last mile device comprises a router or a server.

10. A system, comprising:
a network comprising a plurality of quantum key distribution nodes, each quantum key distribution node having a direct connection with the other quantum key distribution nodes and associated with a region;
a central key management service device in each region and in hardwired communication with the quantum key distribution node in the region;
a plurality of secondary key management service devices in each region and in wired or wireless communication with the central key management service device; and
a plurality of last mile devices in each region, each of the plurality of last mile devices in hardwired communication with one of the plurality of secondary key management devices in the region.

11. The system of claim 10, wherein:
one of the quantum key distribution nodes is configured to receive a quantum key and to distribute the quantum key to the other quantum key distribution nodes over a subset of the direct connections;
one of the plurality of quantum key distribution nodes is configured to communicate the quantum key to the central key management service node in the region;
the central key management service node is configured to communicate the quantum key to one of the secondary key management service nodes in the region;
the secondary key management service node is configured to communicate the quantum key to one of the last mile devices in the region; and
the last mile device is configured to use the quantum key to encrypt or decrypt data.

12. The system of claim 11, wherein each region is defined by a geographical area.

13. The system of claim 11, wherein each region is defined by a building.

14. The system of claim 11, wherein the direct connections comprise an optical fiber or a satellite link.

15. The system of claim 11, wherein the last mile device comprises the secondary key management node.

16. The system of claim 11, wherein the last mile device is hardwired to the secondary key management node.

17. The system of claim 11, wherein the last mile device comprises a router or a server.

18. The system of claim 11, wherein the central key management service node communicates the quantum key to the secondary key management service node using symmetric encryption.

19. The system of claim 11, further comprising a plurality of databases in the region, wherein the central key management service node communicates the quantum key to the secondary key management service node using distributed database mechanisms.

20. The system of claim 11, wherein the central key management service nodes and/or the secondary key management service nodes comprise hardware secure module devices.
